(19) United States
(12) Patent Application Publication
(10) Pub. No.: US 2012/0139924 A1
(43) Pub. Date: Jun. 7, 2012

(54) DYNAMIC ADAPTION OF ANIMATION TIMEFRAMES WITHIN A COMPLEX GRAPHICAL USER INTERFACE

(75) Inventors: Hans-Ulrich Oldengott, Jettingen (DE); Thomas Ritter, Herrenberg (DE); Hans-Christian Sperker, Bamberg (DE)

(73) Assignee: INTERNATIONAL BUSINESS MACHINES CORPORATION, Armonk, NY (US)

(21) Appl. No.: 13/308,598

(22) Filed: Dec. 1, 2011

(30) Foreign Application Priority Data
Dec. 3, 2010 (EP) 10193723.3

(51) Int. Cl. G06T 13/00

(52) U.S. Cl. 345/473

(57) ABSTRACT

The dynamic adaption of animation timeframes includes selecting animations to be displayed on a graphical user interface (GUI) and aligning the selected animations in a queue. An overall duration of time needed to display the selected animations in the queue is determined based on timeframes associated with the selected animations in the queue. The overall duration of time is compared with a predefined time value. If the overall duration of time is greater than the predefined time, a timeframe associated with at least one of the selected animations in the queue is reduced until the overall duration of time is less than or equal to the predefined time value. Each of the selected animations in the queue are sequentially displayed on the GUI for an amount of time that is based on the timeframes associated with the selected animations in the queue.

### PRIORITY

The present application claims priority to European Patent Application No. 10193723.3, filed on 3 Dec. 2010, and all the benefits accruing therefrom under 35 U.S.C. §119, the contents of which in its entirety are herein incorporated by reference.

### BACKGROUND

The present invention relates to dynamic adaption of animation timeframes within graphical user interfaces (GUI). More specifically, the present invention relates to adaption of the duration of an animation based on the number of animations to be played in a queue.

Consider a system in which a user can create an arbitrary number of processes. All of these processes need a predefined arbitrary timeframe to finish, and the system executes these processes, in the best case in parallel and in the worst case in sequence. Thus, the time needed to finish all of the processes created by the user is proportional to the number or amount of processes. An abstract example for such a system is an interactive presentation on which a user can trigger animations by moving a cursor over certain objects. A more concrete example is an application for playing recordings of slideshows, where the user has the ability to navigate through the recording by moving the cursor along the list of slides. If the cursor is over a slide, it's part of the recording gets played. If the user then moves the cursor over a number of further slides, e.g., he is searching for something in the presentation, he has to wait until all of the slides of the recording touched by the cursor get played up to the point where the cursor is resting over a slide. Thus, while the slide on which the cursor rests may indicate the likeliest point in the recording containing the information of interest to the user, the user has to wait for the previous slides to get played. This time period can vary depending on the number of slides that are activated and waiting to be played.

If every animation per slide takes approximately the same amount of time to play, the overall time needed will be the product of the slides in the queue and the playing time of a single slide. However, just to skip the information of some slides is not appropriate, because it will prevent some information from being shown to the user. Hiding this information from the user may lead to the user's assumption that the information searched is located in another part of the slideshow, and this assumption may be wrong. However, just to set the time of the animation per slide to a smaller value can cause problems, too. If the new value chosen for the duration is too big, the problem is only shunted to a later time. If the value chosen is too small, the animation of a single slide is hardly noticeable, making it impossible for the user to search for the needed information. Either way, the cumulated time needed to play all waiting slides grows in a linear manner with the number of slides to be displayed.

U.S. Pat. No. 6,542,164 B1 discloses a timing and velocity control for displaying graphical information. Time and velocity metrics are used to control when information about a graphical object to which a cursor points is displayed on a video display. The time metric is used to ensure that a non-negligible amount of time passes between the time at which the cursor initially points to the graphical object and the time at which the information about the graphical object is displayed on the video display. The time delay helps to eliminate such information being displayed inadvertently when the user quickly passes the cursor over graphical objects in the video display. In addition, the timing control facilitates the shortening of the delay when it appears that the user wishes to browse amongst several related graphical objects that are shown in the video display. For example, when it appears that the user wishes to browse tools on the tool bar, the delay is shortened. The velocity metric is used to determine the likelihood that the user intended to point to the graphical object and serves to minimize instances where undesired information about the graphical object is displayed.

U.S. Pat. No. 6,583,781 B1 discloses methods, systems and computer program products for controlling events associated with user interface elements by capturing user intent based on pointer movements. Methods, systems and computer program products are described which control events associated with an element of a user interface by determining a characteristic of pointer movement of a pointing device and adjusting a condition for triggering an event associated with the element based on the determined characteristic of pointer movement. The triggering of the event is controlled by utilizing the adjusted condition. By determining characteristics of pointer movement, a user's intent may be inferred from the pointer movement and, based on the inferred intent the conditions for triggering of events may be adjusted consistent with such inferred intent.

U.S. Pat. No. 7,107,530 B2 discloses a method, system and program product for displaying a tooltip based on content within the tooltip. A size of the content within the tooltip is first determined based on any known measurement such as a quantity of characters, bytes, etc. Once the size has been determined a display time is calculated by using the size in a predetermined algorithm. The tooltip is then displayed for the duration of the calculated display time, after which the tooltip is closed. According to a first aspect, a method for displaying a tooltip based on content within the tooltip is described. The method includes: determining a feature of the content within the tooltip; calculating a display time for the tooltip based on the feature of the content; and displaying the tooltip for the calculated display time. According to a second aspect, a method for displaying a tooltip based on content within the tooltip is described. The method includes: determining a size of the content within the tooltip; determining a product by multiplying the size by a predetermined time factor; calculating a display time for the tooltip by summing the product and a base time; and displaying the tooltip for the display time, wherein the tooltip is closed when the display time has elapsed. According to a third aspect, a system for displaying a tooltip based on content within the tooltip is described. The system includes: a content system for determining a size of the content within the tooltip; a time system for calculating a display time for the tooltip based on the size; and a display system for displaying the tooltip for the calculated display time.

U.S. Patent Application No. US2010/0070860A1 discloses a method for animated cloud tags derived from deep tagging. A tagging engine is used to analyze deep tag data associated with a portion of media and to process the tagging data into a deep tag cloud. Tag clouds can contain snapshot information about a particular media stream segment, and tag clouds for an entire duration or for portions of a media stream are aggregated. Aggregated tag clouds are processed and compiled into a slideshow form. The tag clouds in the slideshow are animated and presented to summarize media that includes the deep tags from which the tag clouds were derived.

### SUMMARY

According to exemplary embodiments, a method, apparatus, and computer program product for dynamic adaption of animation timeframes is provided. The dynamic adaption of animation timeframes includes selecting animations to be displayed on a graphical user interface (GUI) and aligning the selected animations in a queue. An overall duration of time needed to display the selected animations in the queue is determined based on timeframes associated with the selected animations in the queue. The overall duration of time is compared with a predefined time value. If the overall duration of time is greater than the predefined time, a timeframe associated with at least one of the selected animations in the queue is reduced until the overall duration of time is less than or equal to the predefined time value. Each of the selected animations in the queue is sequentially displayed on the GUI for an amount of time that is based on the timeframes associated with the selected animations in the queue.

### BRIEF DESCRIPTION OF THE SEVERAL VIEWS OF THE DRAWINGS

The drawings referenced in the present application are only used to exemplify typical embodiments of the present invention and should not be considered to be limiting the scope of the present invention.

FIG. 1 shows a graph representing the time needed to play a plurality of animations in a sequence;

FIG. 2 shows a graph representing the time needed to play a plurality of animations in a sequence with a decreased timeframe;

FIG. 3 gives a figurative overview of a graphical user interface (GUI) in accordance with an embodiment of the invention;

FIG. 4 shows a graph representing an exemplary function to calculate a reduced timeframe for animations according to an embodiment of the invention;

FIG. 5 shows a comparison of the regular time needed to display a sequence of animations and the time needed according to an embodiment of the invention;

FIG. 6 shows a sequence diagram in accordance with an embodiment of the invention; and

FIG. 7 shows the internal operation of the worker in a GUI in accordance with an embodiment of the invention.

### DETAILED DESCRIPTION

An embodiment of present invention is directed to dynamic adaptation of animation timeframes for display on a graphical user interface (GUI). The dynamic adaption of animation timeframes overcomes the challenges faced when a variable number of animations are required to be displayed within a fixed time period. Embodiments described herein allow the reduction of time otherwise needed to display a plurality of animations in a queue to a predefined time value without the risk of skipping or missing needed information within the animations. In accordance with an embodiment described herein, the timeframe of at least the animation to be displayed next is reduced if the overall duration of all of the animations in the queue is greater than the predefined time value. In an embodiment, the processes of calculating the overall duration of animations in the queue and reducing (if needed) the timeframe of the next animation to be displayed are iterated after each displayed animation.

Through this iteration, the process described above is dynamic such that the timeframe for each animation to be displayed is recalculated. If there are only a small number of animations waiting in the queue to be displayed, the timeframe of animation xₙ to be displayed (or played) next may be the originally intended timeframe of the animation xₙ, while if animations have been added to the queue while animation xₙ is being displayed, the timeframe of animation xₙ₊₁ next in the queue may be set to a reduced duration. On the other hand, while the timeframe of an animation xₙ₊₁ currently displayed is reduced, the timeframe of the animation xₙ₊₂ being the next in the queue to be displayed may be reset to the original timeframe if no new animation was added to the queue and the overall duration of the animations in the queue fits the predefined time value after animation xₙ₊₁ has left the queue.

The reduced timeframe of the animations to be displayed may be calculated by a regressive function depending on the number of animations waiting in the queue to be displayed. An example of a regressive function that may be used is shown in the formula (I):

$$y = \frac{10 x + 100}{{x}^{2} + 21 x + 20} \qquad ( I )$$

where “y” is the display duration of the animation to be displayed and “x” is the number of animations in the queue. It should be understood that in the above formula I the values 10, 100, 21, and 20 are chosen as exemplary values only. Other values can be chosen to adapt the regressive function to the requirements of a particular GUI.

The timeframe of an animation may be reduced by increasing the speed at which the animation is displayed. To increase the speed at which the animation is displayed, the number of frames per second displayed can be increased. This simplifies the method since only one value in the animation, i.e., the number of frames per second, has to be amended for reducing the duration of the animation. Comparable increases of the display speed are possible not only for most kinds of animation files (e.g. shockwave dcr-files, flash swf-files, or gif-files), but also for most kinds of video clip files (e.g., wmv-files, mpeg-files, ram-files, or vcl-files). Therefore, embodiments of the invention apply to any kind of information to be displayed on the GUI (e.g., slides of a slideshow, video clips, or emails).

The dynamic adaptation of animation timeframes change the duration of an animation dynamically, depending on the number of animations waiting to be played. In an embodiment, a worker process is used, which takes the first animation from the queue of waiting animations and changes its animation speed which reduces the duration of the first animation before it gets played. The new speed for each animation is calculated by a regressive function depending on the number of animations in the queue waiting to be played. If there are a lot of animations waiting, the first ones get played with a short animation timeframe. While the number of waiting animations decreases the timeframe increases, and if the number of animations increases again the timeframe decreases. This leads to the systems behavior that the user sees all information, at first with a higher speed and later, for points where the cursor is resting which are more likely relevant for a search the speed reduces smoothly to normal. This solution reduces the time taken by all animations respectively to their importance.

Embodiments described herein may be used in any system where an undefined number of processes are triggered by an event, each taking an arbitrary predefined amount of time to present some information, and where the single processes cannot be processed in parallel, to shorten the overall time to finish all processes without losing information. Such behavior is very common in web browsers and therefore web applications, since they only provide one single execution thread. The exemplary processes described herein could also be used to shorten some arbitrary predefined time, e.g. in the networking area. Suppose an application has a predefined time interval to check emails. Depending on the activity level of the user, this interval could be shorter if the user is very active and it is likely that he needs new mails as soon as they arrive at the mail server, or longer if the user is inactive. If the interval was always a short period of time, for a large amount of users this would lead to a higher load at the mail server. By adapting the interval dynamically, depending on the activity level of the user, the server load is distributed more equally. Therefore, the GUI according to embodiments described herein may also be an integrated part of an email browser program.

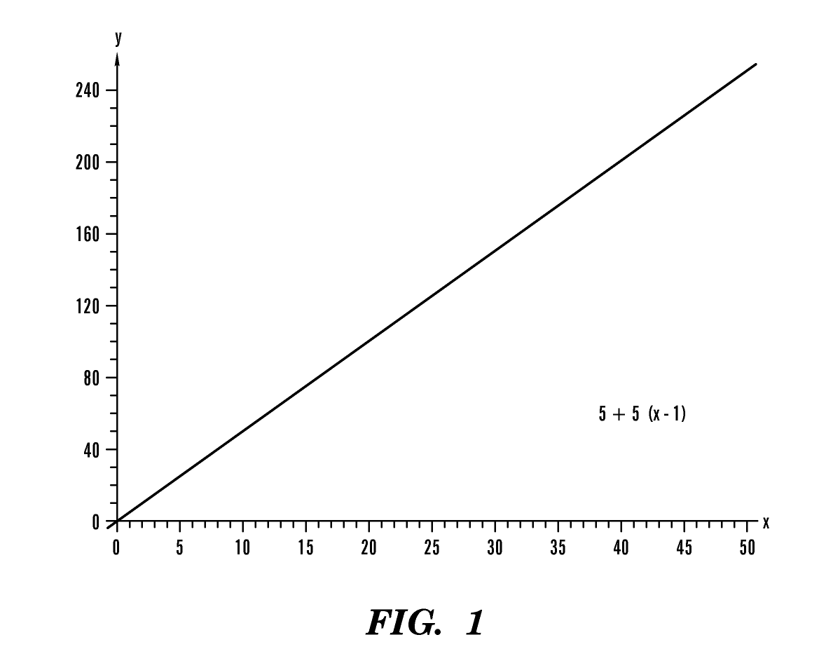

These, and other features, will now be described with regard to FIGS. 1-7. Referring now to FIG. 1, the time needed to play all animations in a sequence with the same duration per animation is generally shown. Here, a duration of 5 seconds is assumed by way of non-limiting example. With an increasing number of animations in the sequence, the time needed to play all animations increases linearly according to the equitation 5+5(x−1).

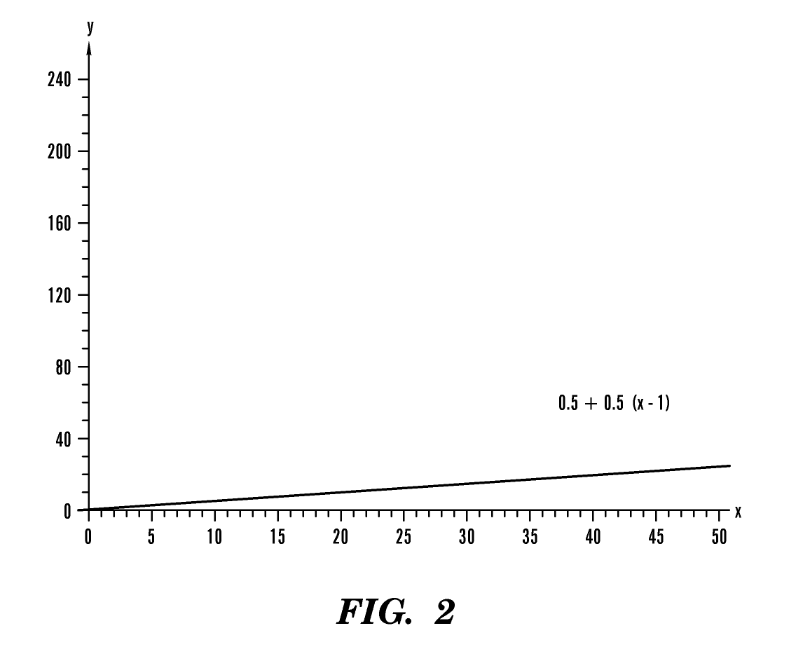

In FIG. 2 a graph is shown representing the time needed to display animations in a sequence with the same duration per animation. As shown in FIG. 2, the time per animation is set to 0.5 seconds. Accordingly, the overall time needed to play the same number of animations is reduced in comparison to the graph shown in FIG. 1 by a factor of ten. However, the time for each animation is very short.

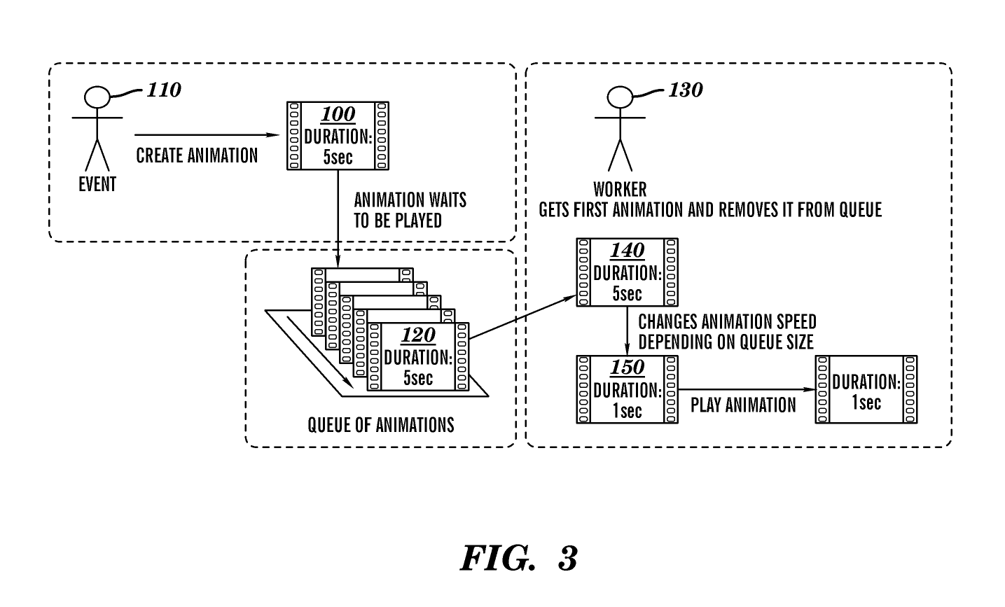

FIG. 3 depicts an overview of how the exemplary GUI works. Animations 100 to be displayed are triggered by an event 110. The triggered animations 100 are aligned in a queue 120. A worker process 130 calculates the overall time needed to display all animations 100 in the queue 120, and compares the calculated overall time needed with a predefined time value. If the calculated time needed to display all animations 100 in the queue 120 is greater than the predefined time value, the worker process 130 sets the timeframe 140 of the animation 100 to be played next to a reduced timeframe 150, so that the time needed to play the animations 100 fits to the predefined time value.

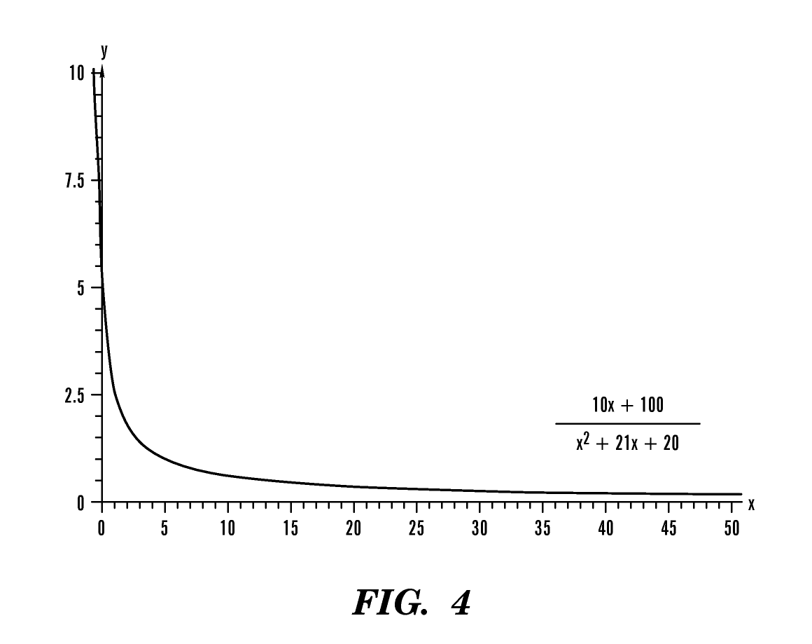

FIG. 4 shows a graph representing an exemplary regressive function to reduce the overall time needed to display all animations in a queue in dependence on the number of animations waiting in the queue. As can be seen, the time needed to display an animation in a queue decreases with an increasing number of animations in the queue.

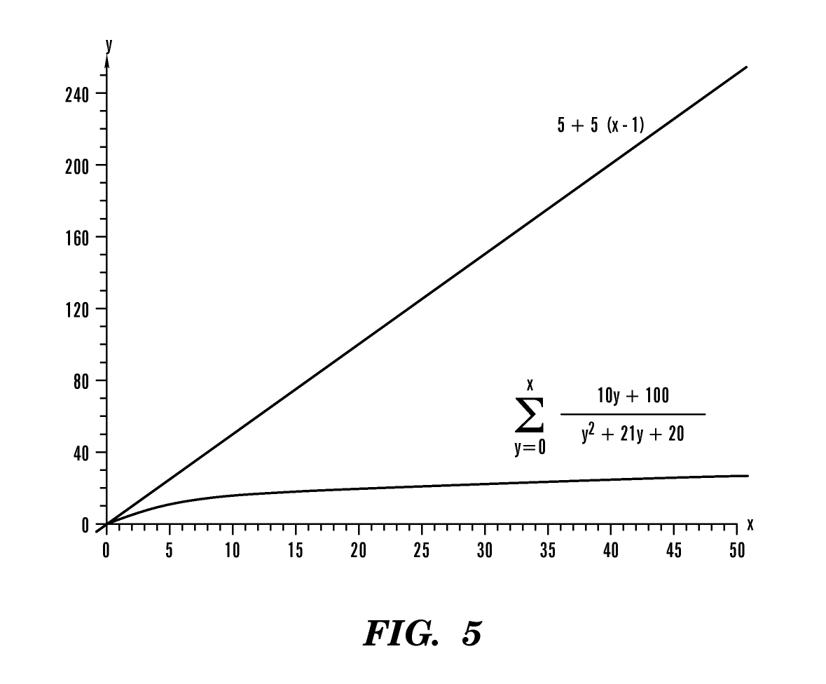

FIG. 5 shows as a comparison the graphs representing the times needed to play all animations in a queue at a fixed timeframe and at a timeframe reduced according to an embodiment. As can be seen in the lower graph, the overall time needed increases non-linear up to a limiting value, i.e., the predefined time value.

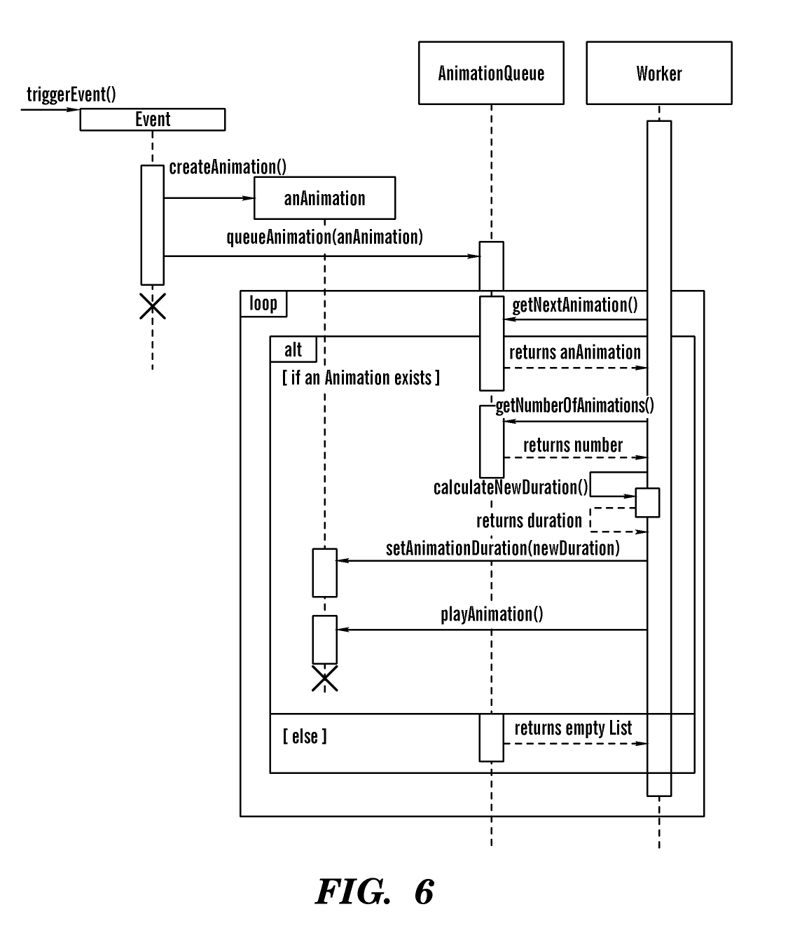

FIG. 6 shows a sequence diagram illustrating a method and GUI in accordance with exemplary embodiments. After the user has triggered an event, the event creates an animation, e.g., a part of the slideshow recording belonging to a slide selected by the user. After the animation is created, it gets queued in the queue of animations waiting to be displayed. This queue is processed by a worker process. The worker process gets the next waiting animation from the queue. If the worker process receives an animation it requests the number of animations waiting from the queue, calculates the new duration for the received animation, changes the duration of the animation and plays it. These steps are repeated until the worker process gets terminated because the application gets closed.

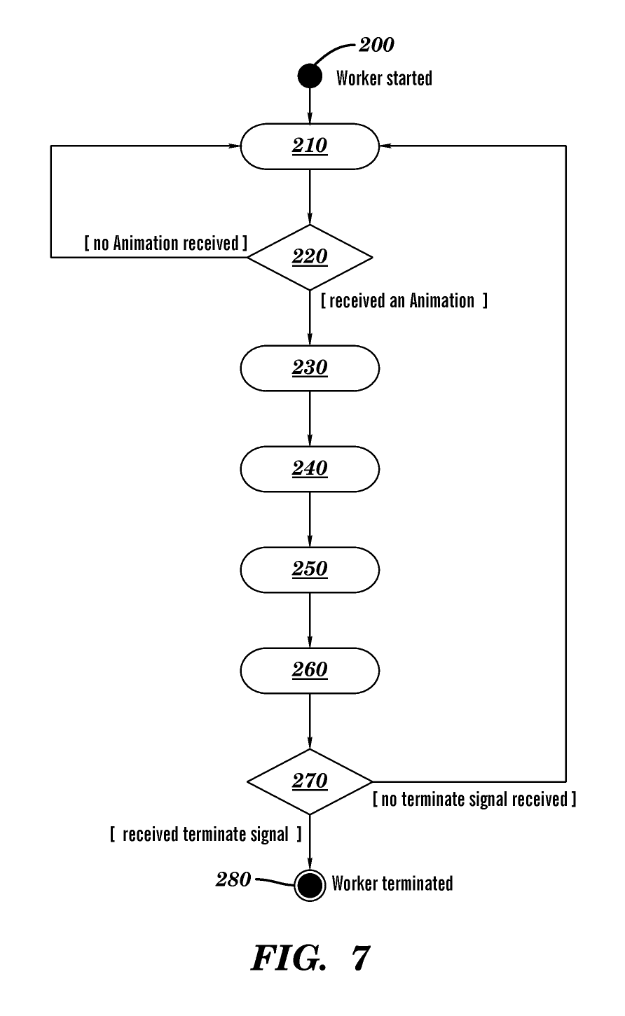

In FIG. 7 a flowchart of the internal operations of a worker process in accordance with an embodiment is general shown. A worker process 200 of an application is set from an idle state to run when an animation or a plurality of animations is triggered by a user. In block 210 the worker process gets the next animation of the queue of animations triggered by the user. If there is no animation in the queue in block 220 a feedback loop is started until an animation is in queue. If animations are in the queue, in block 230 the number of animations in the queue is determined as well as the overall duration of the animations in the queue. Based on the number of animations and the overall duration, a new timeframe for the animation to be displayed next is calculated in block 240. The new timeframe is calculated with a certain function, e.g., a regressive function, depending on the number of animations in the queue. The calculated new timeframe is set for the animation to be displayed next in block 250, and in block 260 the animation gets displayed with the new timeframe. In block 270 it is determined whether there are further animations in queue to be displayed. If so, a feedback loop restarts the process at block 210. If no further animations are in the queue, the worker process is set to an idle state in block 280, waiting for new animations to be selected by the user.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing dynamic adaption of animation timeframes, the method comprising:
selecting animations to be displayed on a graphical user interface (GUI);
aligning the selected animations in a queue;
determining an overall duration of time needed to display the selected animations in the queue, the determining an overall duration of time responsive to timeframes associated with the selected animations in the queue;
comparing the overall duration of time with a predefined time value;
upon determining, responsive to the comparing, that the overall duration of time is greater than the predefined time value:
reducing a timeframe associated with at least one of the selected animations in the queue until the overall duration of time is less than or equal to the predefined time value; and
sequentially displaying the selected animations in the queue on the GUI, the displaying of each of the selected animations for an amount of time that is based on the timeframes associated with the selected animations in the queue.

2. The method according to claim 1, wherein the determining an overall duration of time and the comparing are iterated after each of the selected animations are displayed.

3. The method according to claim 1, wherein the reduced timeframe is calculated by a regressive function depending on a number of animations waiting in the queue to be displayed.

4. The method according to claim 1, wherein the reducing a timeframe includes increasing a speed at which the at least one of the selected animations in the queue is displayed.

5. The method according to claim 4, wherein the increasing the speed includes increasing a number of frames per second to be displayed.

6. The method according to claim 1, wherein the selected animations are slides of at least one of a slide show and video clips.

7. The method according to claim 1, wherein the selected animations are email messages.

8. An apparatus for implementing dynamic adaption of animation timeframes, the apparatus comprising:
a processor configured for:
selecting animations to be displayed on a graphical user interface (GUI);
aligning the selected animations in a queue;
determining an overall duration of time needed to display the selected animations in the queue, the determining an overall duration of time responsive to timeframes associated with the selected animations in the queue;
comparing the overall duration of time with a predefined time value;
upon determining, responsive to the comparing, that the overall duration of time is greater than the predefined time value:
reducing a timeframe associated with at least one of the selected animations in the queue until the overall duration of time is less than or equal to the predefined time value; and
sequentially displaying the selected animations in the queue on the GUI, the displaying of each of the selected animations for an amount of time that is based on the timeframes associated with the selected animations in the queue.

9. The apparatus according to claim 8, wherein the determining an overall duration of time and the comparing are iterated after each of the selected animations are displayed.

10. The apparatus according to claim 8, wherein the reduced timeframe is calculated by a regressive function depending on a number of animations waiting in the queue to be displayed.

11. The apparatus according to claim 8, wherein the reducing a timeframe includes increasing a speed at which the at least one of the selected animations in the queue is displayed.

12. The apparatus according to claim 11, wherein the increasing the speed includes increasing a number of frames per second to be displayed.

13. The apparatus according to claim 8, wherein the selected animations are at least one of slides in a slide show, video clips, and email messages.

14. A computer program product for implementing dynamic adaption of animation timeframes, the computer program product comprising:
a computer readable storage medium having computer readable code embodied therewith, the computer readable program code comprising:
computer readable program code configured for:
selecting animations to be displayed on a graphical user interface (GUI);
aligning the selected animations in a queue;
determining an overall duration of time needed to display the selected animations in the queue, the determining an overall duration of time responsive to timeframes associated with the selected animations in the queue;
comparing the overall duration of time with a predefined time value;
upon determining, responsive to the comparing, that the overall duration of time is greater than the predefined time value:
reducing a timeframe associated with at least one of the selected animations in the queue until the overall duration of time is less than or equal to the predefined time value; and
sequentially displaying the selected animations in the queue on the GUI, the displaying of each of the selected animations for an amount of time that is based on the timeframes associated with the selected animations in the queue.

15. The computer program product according to claim 14, wherein the determining an overall duration of time and the comparing are iterated after each of the selected animations are displayed.

16. The computer program product according to claim 14, wherein the reduced timeframe is calculated by a regressive function depending on a number of animations waiting in the queue to be displayed.

17. The computer program product according to claim 14, wherein the reducing a timeframe includes increasing a speed at which the at least one of the selected animations in the queue is displayed.

18. The computer program product according to claim 17, wherein the increasing the speed includes increasing a number of frames per second to be displayed.

19. The computer program product according to claim 14, wherein the selected animations are slides of at least one of a slide show and video clips.

20. The computer program product according to claim 14, wherein the selected animations are email messages.
